(19) United States
(12) Patent Application Publication
(10) Pub. No.: US 2015/0366002 A1
(43) Pub. Date: Dec. 17, 2015

(54) ANTENNA STRUCTURE, COMMUNICATION APPARATUS AND ELECTRONIC EQUIPMENT

(71) Applicant: Sony Corporation, Toyko (JP)

(72) Inventor: Chi-Yuk CHIU, Hong Kong (HK)

(21) Appl. No.: 14/585,284

(22) Filed: Dec. 30, 2014

(30) Foreign Application Priority Data
Jun. 12, 2014 (CN) 201410260704.2

(51) Int. Cl. H04W 88/06; H01Q 9/04; H04B 1/40

(52) U.S. Cl. CPC H04W 88/06; H04B 1/40; H01Q 9/04

(57) ABSTRACT

Embodiments of the present application provide an antenna structure, communication apparatus and electronic equipment. The antenna structure includes a first antenna and a second antenna configured to perform first network communication; wherein the antenna structure further includes a third antenna located between the first antenna and the second antenna and configured to perform second network communication, the third antenna being connected to a communication module of the second network. By providing the third antenna configured to perform the second network communication between the first antenna and the second antenna configured to perform the first network communication, the correlation between the first antenna and the second antenna may be reduced, and the second network communication may be performed.

### PRIORITY CLAIM AND CROSS-REFERENCE TO RELATED APPLICATION

This application claims priority from Chinese patent application No. 201410260704.2, filed Jun. 12, 2014, the entire disclosure of which is incorporated by reference.

### TECHNICAL FIELD

The present application relates to the field of communication technologies, and in particular to an antenna structure, a communication apparatus and electronic equipment.

### BACKGROUND

As a next generation wireless communication technology, a long-term evolution (LTE) technology can provide higher data rates and better multimedia services. In the

LTE technology, a multiple input multiple output (MIMO) technology is one of the key technologies therein. In the MIMO technology, more than two antennas operating at different frequencies need to be used to receive and transmit signals, thereby not only increasing rate of data transmission, but also improving network coverage.

In a mobile communication terminal using the MIMO technology, a primary antenna and a secondary antenna operating at an identical frequency are usually used to receive and transmit cellular mobile communication signals, and the primary antenna and the secondary antenna may be arranged at the top and bottom of a circuit board of the mobile communication terminal. In order that the mobile communication terminal obtains a good communication performance, the primary antenna and the secondary antenna should be well isolated and less correlated, with an envelope correlation coefficient (ECC) being usually used to feature the correlation between the primary antenna and the secondary antenna. According to a used standard, when an antenna operates at a frequency below 1 GHz, it requires that ECC<0.5, and when an antenna operates at a frequency above 1 GHz, it requires that ECC<0.4.

In the relevant art, in order to meet the requirements of the above used standard, a metal stub may be provided between the primary antenna and the secondary antenna, so as to reduce an envelope correlation coefficient between the primary antenna and the secondary antenna.

It should be noted that the above description of the background is merely provided for clear and complete explanation of the present application and for easy understanding by those skilled in the art. And it should not be understood that the above technical solution is known to those skilled in the art as it is described in the background of the present application.

### SUMMARY

It was found by the inventor that on the one hand, the metal stub between the primary antenna and the secondary antenna functions only to reduce the ECC between the primary antenna and the secondary antenna, which occupies an area in the circuit board, but the function is relatively simple, and does not satisfy the trend of miniaturizing of a mobile terminal; and on the other hand, a wireless fidelity (Wi-Fi) module or the like using the MIMO technology in the mobile terminal may need to be configured with a multi-antenna structure to meet higher communication requirements.

Embodiments of the present application provide an antenna structure, communication apparatus and electronic equipment, in which a metal stub between a primary antenna and a secondary antenna is used as an antenna, thereby the metal stub being able to reduce an ECC between the primary antenna and the secondary antenna, and also being used to receive and transmit wireless signals, and the utilization of the metal stub being improved.

According to a first aspect of the embodiments of the present application, there is provided an antenna structure, including a first antenna and a second antenna configured to perform first network communication; wherein the antenna structure further includes a third antenna located between the first antenna and the second antenna and configured to perform second network communication, the third antenna being connected to a communication module of the second network.

According to a second aspect of the embodiments of the present application, the first network is a cellular network, and the second network is a global positioning system (GPS) network, a wireless fidelity (Wi-Fi) network, and/or a Bluetooth network.

According to a third aspect of the embodiments of the present application, the third antenna is parallel with or perpendicular to the first antenna and/or the second antenna.

According to a fourth aspect of the embodiments of the present application, the third antenna has a grounding terminal

According to a fifth aspect of the embodiments of the present application, the number of the third antennas is equal to or more than two.

According to a sixth aspect of the embodiments of the present application, there is provided a communication apparatus, including the antenna structure as described in either one of the first and fifth aspects of the embodiments, a communication module of the first network and the communication module of the second network; wherein the first antenna and the second antenna are electrically connected to the communication module of the first network, respectively, and the third antenna is electrically connected to the communication module of the second network.

According to a seventh aspect of the embodiments of the present application, the communication module of the first network is a communication module of a cellular network, and the communication module of the second network is a communication module of a global positioning system (GPS) network, a communication module of a wireless fidelity (Wi-Fi) network, and/or a communication module of a Bluetooth network.

According to an eight aspect of the embodiments of the present application, there is provided electronic equipment, including the communication apparatus as described in either one of the sixth and seventh aspects of the embodiments.

According to a ninth aspect of the embodiments of the present application, wherein the electronic equipment further includes a housing, the third antenna being provided on an inner surface or outer surface of the housing, or being embedded in the housing.

According to a tenth aspect of the embodiments of the present application, the housing is made from a nonmetal material, and the third antenna is made from a metal material.

Advantages of the embodiments of the present application resides in that a third antenna configured to perform second network communication is provided between a first antenna and a second antenna configured to perform first network communication, thereby not only reducing correlation between the first antenna and the second antenna, but also being able to perform second network communication.

With reference to the following description and drawings, embodiments of the present application are disclosed in detail, and principles of the present application and the manners of use are indicated. It should be understood that the scope of the embodiments of the present application is not limited thereto. The embodiments of the present application contain many alternations, modifications and equivalents within the spirits and scope of the terms of the appended claims.

Features that are described and/or illustrated with respect to one embodiment may be used in the same way or in a similar way in one or more other embodiments and/or in combination with or instead of the features of the other embodiments.

It should be emphasized that the term “includes/including” when used in this specification is taken to specify the presence of stated features, integers, steps or components but does not preclude the presence or addition of one or more other features, integers, steps, components or groups thereof.

### BRIEF DESCRIPTION OF THE DRAWINGS

The drawings are included to provide further understanding of the present application, which constitute a part of the specification and illustrate the preferred embodiments of the present application, and are used for setting forth the principles of the present application together with the description. The accompanying drawings described below are some embodiments of this application, and other accompanying drawings may be obtained by those skilled in the art according to these accompanying drawings without making an inventive effort. In the drawings:

FIG. 1 is a schematic diagram of the antenna structure of Embodiment 1 of this application;

FIG. 2 is a schematic diagram of variation of an S parameter between a first terminal and a second terminal along with a signal frequency in a case where there exists no third antenna;

FIG. 3 is a schematic diagram of variation of efficiencies of a first antenna and a second antenna along with a signal frequency in a case where there exists no third antenna;

FIG. 4 is a schematic diagram of variation of ECC between the first antenna and the second antenna along with a signal frequency in a case where there exists no third antenna;

FIG. 5 is a schematic diagram of variation of the S parameter between the first terminal, the second terminal and the third terminal along with a signal frequency in a case where there exists a third antenna;

FIG. 6 is a schematic diagram of variation of efficiencies of a first antenna, a second antenna and the third terminal along with a signal frequency in a case where there exists a third antenna;

FIG. 7 is a schematic diagram of variation of ECC between the first antenna and the second antenna along with a signal frequency in a case where there exists a third antenna;

FIG. 8 is a schematic diagram of a housing of the electronic equipment using the communication apparatus of Embodiment 2 of this application; and

FIG. 9 is a block diagram of the systematic structure of the electronic equipment of Embodiment 3 of this application.

### DETAILED DESCRIPTION

The foregoing and other features of the present application will be apparent with reference to the following description and attached drawings. In the description and drawings, particular embodiments of the application have been disclosed in detail as being indicative of some of the ways in which the principles of the application may be employed, but it is understood that the application is not limited to the described embodiments. Rather, the application includes all changes, modifications and equivalents coming within the scope of the appended claims.

### Embodiment 1

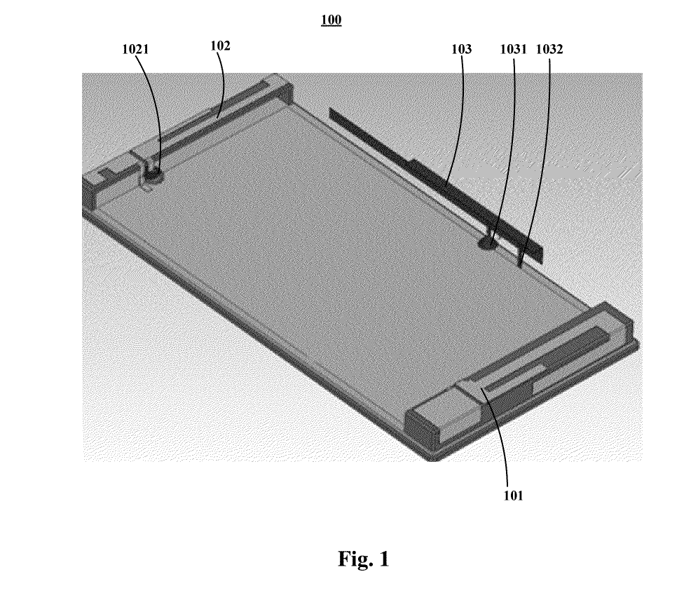

An embodiment of the present application provides an antenna structure. FIG. 1 is a schematic diagram of the antenna structure of Embodiment 1 of this application. As shown in FIG. 1, the antenna structure 100 includes a first antenna 101, a second antenna 102 and a third antenna 103.

The first antenna 101 and the second antenna 102 are configured to perform first network communication. The third antenna is located between the first antenna 101 and the second antenna 102 and is configured to perform second network communication. The third antenna is connected to a communication module of the second network.

In the embodiments of this application, the first network and the second network may be different networks. For example, the first network may be a cellular network, and the second network may be a global positioning system (GPS) network, a wireless fidelity (Wi-Fi) network, and/or a Bluetooth network; or the first network may be a global positioning system (GPS) network, a wireless fidelity (Wi-Fi) network, and/or a Bluetooth network, and the second network may be a cellular network. Of course, this application is not limited thereto, and the first network and the second network may be other types of communication networks. Generally, a signal frequency of the cellular network may be 704-960 MHz, 1710-2170 MHz or 2500-2690 MHz, a signal frequency of the global positioning system (GPS) network may be 1575 MHz, a signal frequency of a 2.4 GHz wireless fidelity (WI-FI) network may be 2400-2484 MHz, and a signal frequency of the Bluetooth network may be 2400-2484 MHz.

In the embodiments of this application, the first antenna 101 and the second antenna 102 may be a primary antenna and a secondary antenna of electronic equipment configured with the antenna structure of the embodiment of this application, respectively, with their particular structures and manners of communication being identical to those of the relevant art, which shall not be described herein any further.

In this embodiment, the third antenna is provided between the first antenna and the second antenna, and the first antenna and the second antenna may be set in parallel. However, the embodiment of this application is not limited thereto, and the first antenna and the second antenna may not be in parallel, and there may be an included angle between extension lines of them.

As shown in FIG. 1, the first antenna 101 and the second antenna 102 are set in parallel at two opposite sides of the electronic equipment, and the third antenna 103 is provided between the first antenna 101 and the second antenna 102, and is perpendicular to the first antenna 101 and the second antenna 102. In this way, by providing the third antenna 103, not only an ECC between the first antenna 101 and the second antenna 102 may be reduced, but also the third antenna 103 may be taken as an antenna of the second network to perform the second network communication.

In the example of FIG. 1, the third antenna 103 is perpendicular to the first antenna 101 and the second antenna 102, and is provided at a side perpendicular to the two opposite sides of the electronic equipment. However, this embodiment is not limited thereto, and as the variation of the positions of the first antenna 101 and the second antenna 102 on the electronic equipment, the third antenna 103 may also be provided at other parts of the electronic equipment and/or keep other included angles relative to the first antenna 101 and the second antenna 102, only if it is kept between the first antenna 101 and the second antenna 102. And even though the positions of the first antenna 101 and the second antenna 102 on the electronic equipment are not varied, such as being provided in parallel at the two opposite sides of the electronic equipment, the third antenna 103 may still be provided at another included angle with respect to the first antenna 101 and the second antenna 102, rather than being perpendicular to them.

In the embodiments of this application, the third antenna 103 may be a stub between the first antenna 101 and the second antenna 102, and may be connected to a communication module of the second network. For example, the third antenna may be connected to any one of a communication module of a global positioning system (GPS) network, a communication module of a wireless fidelity (Wi-Fi) network, and a communication module of a Bluetooth network, or the third antenna may be connected to at least two of the above three modules. In this embodiment, the third antenna may be made from a conductive material, for example, the conductive material may be a metal.

In this embodiment, a frequency of a signal transmitted and received by the second network decides an operating frequency needing to be met by the third antenna. And in this embodiment, a shape parameter of the third antenna 103 may also be adjusted, so as to set its operating frequency, thereby making the third antenna perform the second network communication. The relevant art may be referred to for a particular manner of adjusting a shape parameter to set an operating frequency of the antenna, which shall not be described herein any further.

In the embodiment of this application, as shown in FIG. 1, the first antenna 101 may have a first terminal (not shown), the second antenna 102 may have a second terminal 1021, and the third antenna 103 may have a third terminal 1031, the third terminal 1031 being connected to a signal receiving/transmitting terminal of the communication module of the second network, so as to fulfill the function of communication of the second network. Of course, this application is not limited thereto, and the third terminal may not be provided, while an antenna pattern is directly connected to the signal receiving/transmitting terminal of the communication module.

In the embodiment of this application, as shown in FIG. 1, the third antenna 103 may further have a grounding terminal 1032, thereby providing a grounding path for the third antenna.

In this embodiment, as shown in FIG. 1, the number of the third antenna 103 may be one. However, this embodiment is not limited thereto, and there may be more than one antenna. Therefore, the more than one third antennas may be connected to more communication modules of the second network, thereby further reducing the ECC between the first antenna and the second antenna or increasing a bandwidth to which a low ECC corresponds.

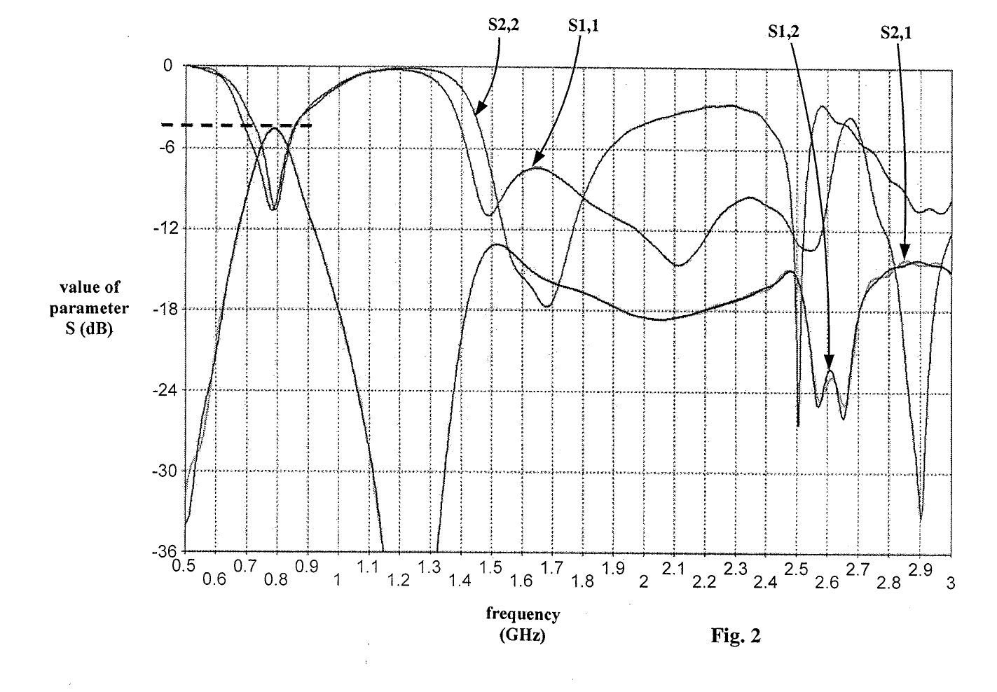

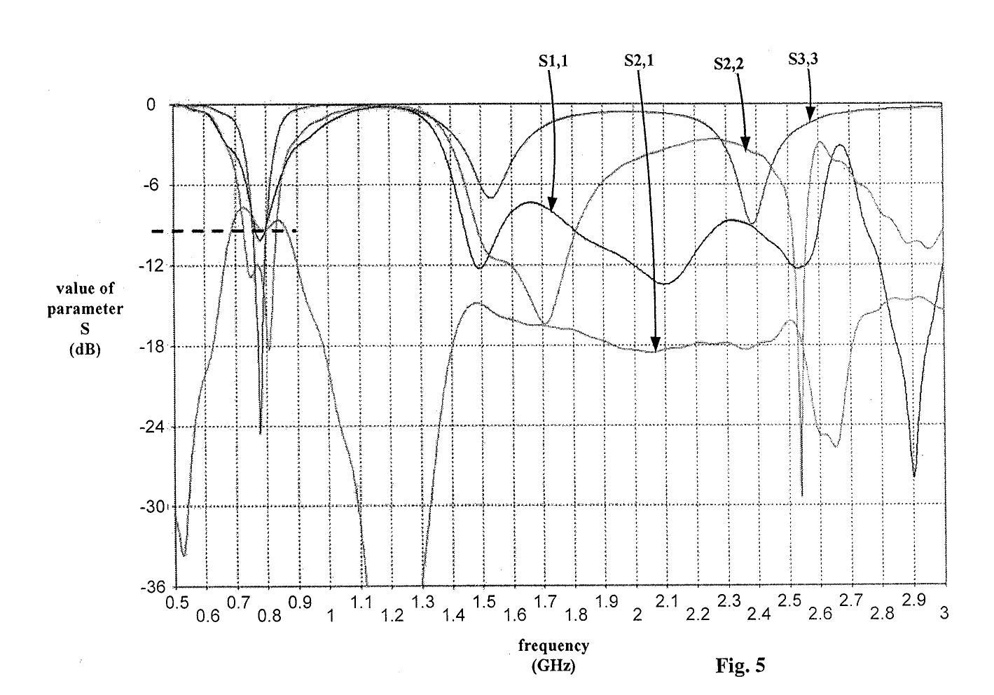

FIGS. 2-4 show a schematic diagram of variation of an S parameter between the first terminal and the second terminal along with a signal frequency, a schematic diagram of variation of efficiencies of the first antenna and the second antenna along with a signal frequency, and a schematic diagram of variation of ECC between the first antenna and the second antenna along with a signal frequency, in a case where there exists no third antennal FIGS. 5-7 show a schematic diagram of variation of the S parameter between the first terminal, the second terminal and the third antenna along with a signal frequency, a schematic diagram of variation of efficiencies of the first antenna, the second antenna and the third antenna along with a signal frequency, and a schematic diagram of variation of ECC between the first antenna and the second antenna along with a signal frequency, in a case where there exists a third antenna.

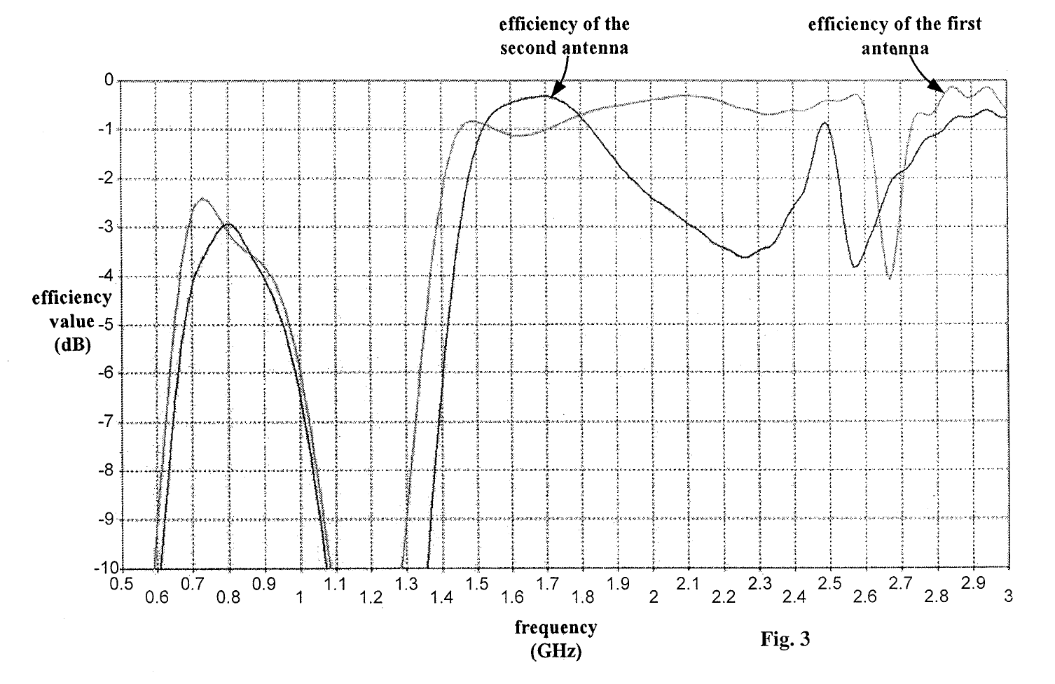

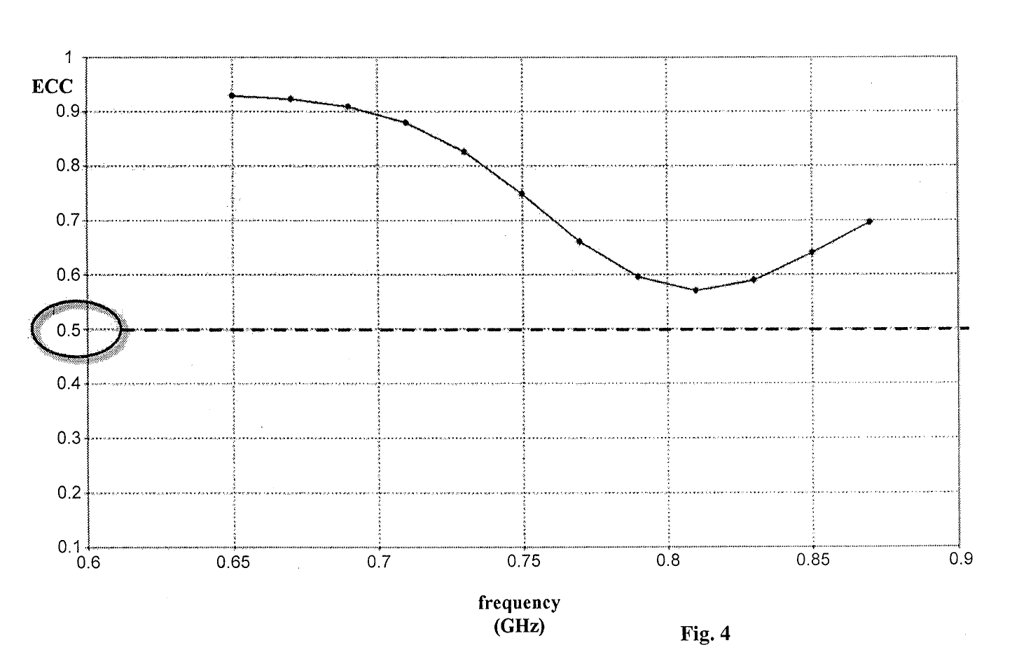

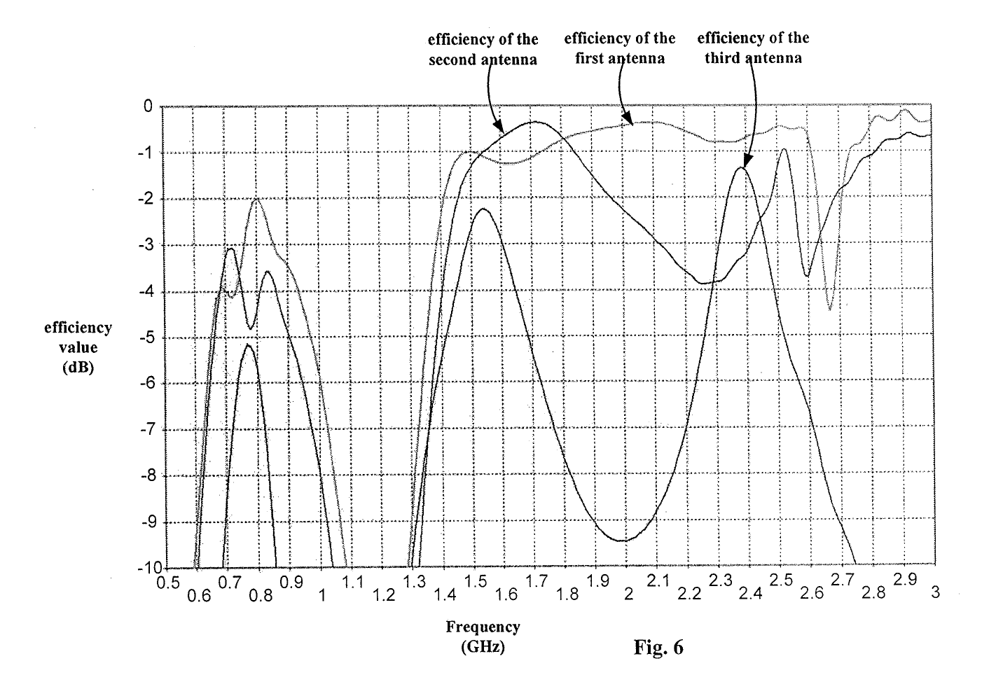

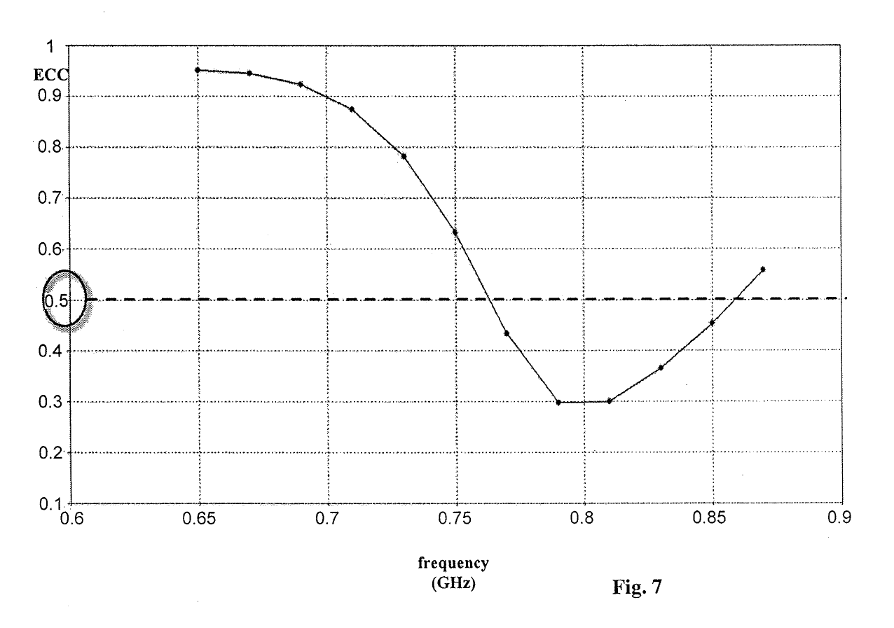

It can be seen from comparison of FIG. 7 and FIG. 4, in the case where there exists a third antenna, the ECC between the first antenna and the second antenna is outstandingly reduced in frequencies greater than 0.7 GHz; as shown by the marks at the dotted lines of FIGS. 5 and 2, when the frequency is 0.8 GHz, a parameter “S2,1” in FIG. 5 is lower than a parameter “S2,1” in FIG. 2 by about 6 dB; that is, in the case where there exists a third antenna, coupling between the first antenna and the second antenna is lowered, which is in a linear relation with the ECC; and it can be seen from comparison of FIG. 6 and FIG. 3, in the case where there exists a third antenna, the efficiency of the first antenna does not attenuate.

According to the embodiment of this application, by providing the third antenna configured to perform the second network communication between the first antenna and the second antenna configured to perform the first network communication, the correlation between the first antenna and the second antenna may be reduced, and the second network communication may be performed, thereby increasing the utilization of the third antenna, and improving the performances of the first antenna and the second antenna.

### Embodiment 2

Embodiment 2 provides a communication apparatus, including the antenna structure 100 described in Embodiment 1. The communication apparatus may include the first antenna 101, the second antenna 102, the third antenna 103, the communication module of the first network and the communication module of the second network; wherein, the first antenna 101 and the second antenna 102 may be electrically connected to the communication module of the first network, respectively, and the third antenna 103 may be electrically connected to the communication module of the second network.

In the embodiments of this application, Embodiment 1 may be referred to for the description of the first antenna 101, the second antenna 102 and the third antenna 103, which shall not be described herein any further.

In the embodiments of this application, the communication module of the first network may be a communication module of a cellular network, and the communication module of the second network may be a communication module of a global positioning system (GPS) network, a communication module of a wireless fidelity (Wi-Fi) network, and/or a communication module of a Bluetooth network. However, the embodiments of this application are not limited thereto, and the communication module of the first network and the communication module of the second network may also be other communication modules.

In this embodiment, the communication module of the second network may be connected to both the third antenna of this embodiment and another antenna; or in a case where there exist more than one third antennas, the more than one third antennas may be connected to the communication module of the second network at the same time. In this way, the communication module of the second network may be connected to multiple antennas, so as to use the MIMO technology for signal transmission.

For example, when the communication module of the second network is a communication module of a global positioning system (GPS) network and a communication module of a wireless fidelity (Wi-Fi) network, the communication module of the GPS network and the communication module of the Wi-Fi network may be connected to the same third antenna 103, and the communication module of the Wi-Fi network may also be connected to another antenna than the third antenna; or in a case where there exist more than one third antennas, the communication module of the GPS network and the communication module of the Wi-Fi network may be connected to the same third antenna 103, and the communication module of the Wi-Fi network may also be connected to another third antenna. In this way, the communication module of the Wi-Fi network may be connected to more than one antenna, so as to use the MIMO technology for signal transmission.

In the embodiment of this application, the first antenna 101, the second antenna 102, the third antenna 103, the communication module of the first network and the communication module of the second network may be provided on a surface of a substrate of the electronic equipment using the communication apparatus.

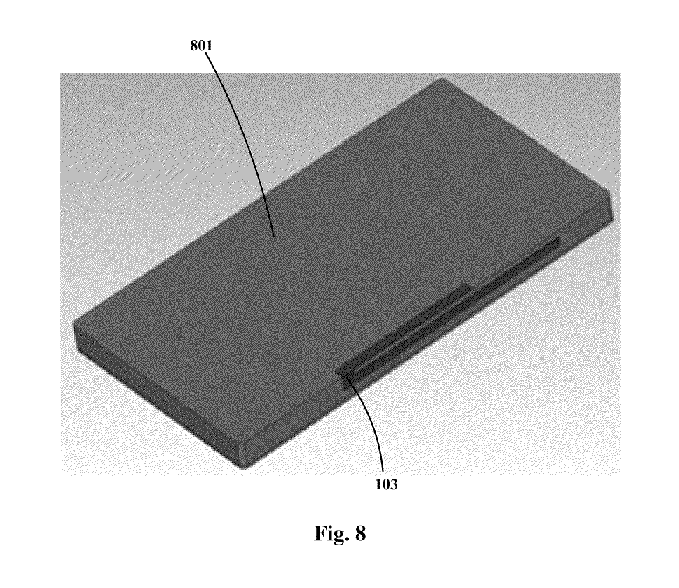

In this embodiment, the third antenna 103 may be provided on a housing of the electronic equipment using the communication apparatus, rather than on the surface of the substrate. FIG. 8 is a schematic diagram of the housing of the electronic equipment using the communication apparatus. As shown in FIG. 8, the third antenna may be provided on an outer surface of the housing 801, and at the same time, a first contact portion electrically connected to the third antenna 103 may be provided on an inner surface of the housing, and a second contact portion electrically connected to the first contact may be provided on the substrate. Therefore, when the substrate is accommodated in the housing, the first contact portion and the second contact portion are electrically connected, thereby making the third antenna be electrically connected to the substrate. However, this embodiment is not limited thereto, and the third antenna 103 may also be provided on the inner surface of the housing 801 or may be embedded within the housing.

In this embodiment, third antennas 103 of different operating frequencies may be provided on the housing 801. In this way, third antennas of different operating frequencies may be provided by replacing the housing, thereby increasing the convenience and flexibility of use.

Furthermore, in this embodiment, the housing 801 may be made from a nonmetal material, such as a plastic, etc. However, this embodiment is not limited thereto, and it may also be other nonmetal materials.

According to the embodiment of this application, by providing the third antenna configured to perform the second network communication between the first antenna and the second antenna configured to perform the first network communication, the correlation between the first antenna and the second antenna may be reduced, and the second network communication may be performed, thereby increasing the utilization of the third antenna, and improving the performances of the first antenna and the second antenna. Furthermore, as the communication module of the second network may be connected to multiple antennas, the communication module of the second network may use the MIMO technology for signal transmission, thereby improving quality of communication.

### Embodiment 3

Embodiment 3 of this application provides electronic equipment, including the communication apparatus described in Embodiment 2.

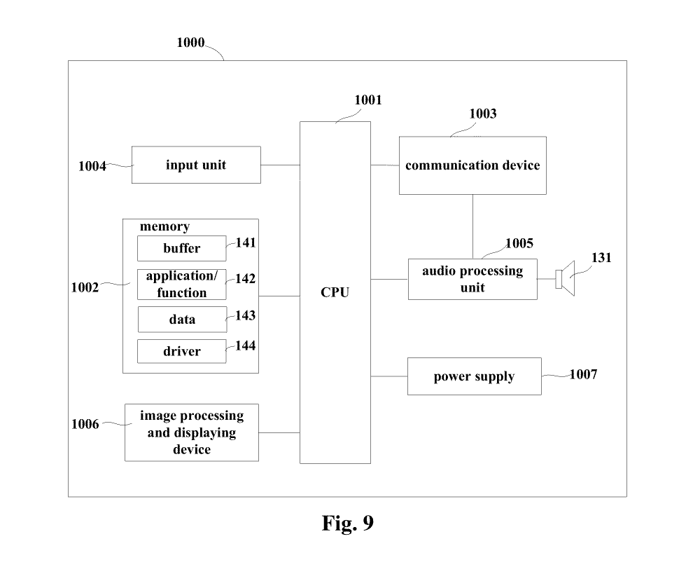

FIG. 9 is a block diagram of the systematic structure of the electronic equipment 1000 of the embodiment of this application. As shown in FIG. 9, the electronic equipment 1000 may include a central processing unit 1001 and a memory 1002, the memory 1002 being coupled to the central processing unit 1001. It should be noted that such a figure is exemplary only, and other types of structures may be used to supplement or replace this structure for the realization of telecommunications functions or other functions.

As shown in FIG. 9, the electronic equipment 1000 may further include a communication device 1003, an input unit 1004, an audio processing unit 1005, an image processing and displaying device 1006, and a power supply 1007. It should be noted that the electronic equipment 1000 does not necessarily include all the parts shown in FIG. 10; furthermore, the electronic equipment 1000 may include other parts not shown in FIG. 10, and the relevant art may be referred to for these parts.

As shown in FIG. 9, the central processing unit 1001 is sometimes referred to as a controller or control, and may include a microprocessor or other processor devices and/or logic devices. The central processing unit 1001 receives input and controls operations of every components of the electronic equipment 1000.

The central processing unit 1001 (sometimes referred to as a controller or control, which may include a microprocessor or other processor devices and/or logic devices) receives input and controls every components and operations of the electronic equipment 1000.

The input unit 1004 provides input to the central processing unit 1001. The input unit 1004 is, for example, a key or a touch input device. The power supply 1007 is used to supply electric power to the electronic equipment 1000. The image processing and displaying device 1006 is used to process and display objects, such as images, videos, and characters, etc.

The memory 1002 is coupled to the central processing unit 1001. The memory 1002 may be a solid-state memory, such as a read-only memory (ROM), a random access memory (RAM), and a SIM card, etc. It may also be such a memory that stores information when the power is interrupted, may be optionally erased and provided with more data. Examples of such a memory are sometimes referred to as an EPROM, etc. The memory 1002 may also be certain other types of devices. The memory 1002 includes a buffer memory 141 (sometimes referred to as a buffer). The memory 1002 may include an application/function storing portion 142 used to store application programs and function programs, or to execute the flow of the operation of the electronic equipment 1000 via the central processing unit 1001.

The memory 1002 may further include a data storing portion 143 used to store data. A driver storing portion 144 of the memory 1002 may include various types of drivers of electronic devices for the communication function and/or for executing other functions (such as application of message transmission, and application of directory, etc.) of the electronic devices.

The communication device 1003 may be the communication apparatus described in Embodiment 2 of this application. And the communication device 1003 may also be coupled to a loudspeaker 131 via the audio processing unit 1005, for providing audio output via the loudspeaker 131. The audio processing unit 1005 may include any appropriate buffers, decoders, and amplifiers, etc.

Furthermore, the electronic equipment of Embodiment 3 of this application may include a substrate and a housing. Embodiment 2 may be referred to for the description of the substrate and the housing, which shall not be described herein any further.

The present application is described above with reference to particular embodiments. However, it should be understood by those skilled in the art that such a description is illustrative only, and not intended to limit the protection scope of the present application. Various variants and modifications may be made by those skilled in the art according to the spirits and principle of the present application, and such variants and modifications fall within the scope of the present application.

Particular embodiments of the present application have been disclosed herein. Those skilled in the art will readily recognize that the present application is applicable in other environments. In practice, there exist many embodiments and implementations. The appended claims are by no means intended to limit the scope of the present application to the above particular embodiments. Furthermore, any reference to “a device to . . . ” is an explanation of device plus function for describing elements and claims, and it is not desired that any element using no reference to “a device to . . . ” is understood as an element of device plus function, even though the wording of “device” is included in that claim.

Although a particular preferred embodiment or embodiments have been shown and the present application has been described, it is obvious that equivalent modifications and variants are conceivable to those skilled in the art in reading and understanding the description and drawings. Especially for various functions executed by the above elements (portions, assemblies, apparatus, and compositions, etc.), except otherwise specified, it is desirable that the terms (including the reference to “device”) describing these elements correspond to any element executing particular functions of these elements (i.e. functional equivalents), even though the element is different from that executing the function of an exemplary embodiment or embodiments illustrated in the present application with respect to structure. Furthermore, although the a particular feature of the present application is described with respect to only one or more of the illustrated embodiments, such a feature may be combined with one or more other features of other embodiments as desired and in consideration of advantageous aspects of any given or particular application.

1. An antenna structure, comprising a first antenna and a second antenna configured to perform first network communication; wherein the antenna structure further comprises:
a third antenna located between the first antenna and the second antenna and configured to perform second network communication, the third antenna being connected to a communication module of the second network.

2. The antenna structure according to claim 1, wherein, the first network is a cellular network, and the second network is a global positioning system (GPS) network, a wireless fidelity (Wi-Fi) network, and/or a Bluetooth network.

3. The antenna structure according to claim 1, wherein, the third antenna is parallel with or perpendicular to the first antenna and/or the second antenna.

4. The antenna structure according to claim 1, wherein, the third antenna has a grounding terminal.

5. The antenna structure according to claim 1, wherein, the number of the third antennas is equal to or more than two.

6. A communication apparatus, comprising the antenna structure as described in claim 1, a communication module of the first network and the communication module of the second network; wherein the first antenna and the second antenna are electrically connected to the communication module of the first network, respectively, and the third antenna is electrically connected to the communication module of the second network.

7. The communication apparatus according to claim 6, wherein the communication module of the first network is a communication module of a cellular network, and the communication module of the second network is a communication module of a global positioning system (GPS) network, a communication module of a wireless fidelity (Wi-Fi) network, and/or a communication module of a Bluetooth network.

8. Electronic equipment, comprising the communication apparatus as claimed in claim 6.

9. The electronic equipment according to claim 8, wherein the electronic equipment further comprises a housing, the third antenna being provided on an inner surface or outer surface of the housing, or being embedded in the housing.

10. The electronic equipment according to claim 9, wherein the housing is made from a nonmetal material, and the third antenna is made from a metal material.

11. A communication apparatus, comprising the antenna structure as described in claim 2, a communication module of the first network and the communication module of the second network; wherein the first antenna and the second antenna are electrically connected to the communication module of the first network, respectively, and the third antenna is electrically connected to the communication module of the second network.

12. The communication apparatus according to claim 11, wherein the communication module of the first network is a communication module of a cellular network, and the communication module of the second network is a communication module of a global positioning system (GPS) network, a communication module of a wireless fidelity (Wi-Fi) network, and/or a communication module of a Bluetooth network.

13. A communication apparatus, comprising the antenna structure as described in claim 3, a communication module of the first network and the communication module of the second network; wherein the first antenna and the second antenna are electrically connected to the communication module of the first network, respectively, and the third antenna is electrically connected to the communication module of the second network.

14. The communication apparatus according to claim 13, wherein the communication module of the first network is a communication module of a cellular network, and the communication module of the second network is a communication module of a global positioning system (GPS) network, a communication module of a wireless fidelity (Wi-Fi) network, and/or a communication module of a Bluetooth network.

15. A communication apparatus, comprising the antenna structure as described in claim 4, a communication module of the first network and the communication module of the second network; wherein the first antenna and the second antenna are electrically connected to the communication module of the first network, respectively, and the third antenna is electrically connected to the communication module of the second network.

16. The communication apparatus according to claim 15, wherein the communication module of the first network is a communication module of a cellular network, and the communication module of the second network is a communication module of a global positioning system (GPS) network, a communication module of a wireless fidelity (Wi-Fi) network, and/or a communication module of a Bluetooth network.

17. A communication apparatus, comprising the antenna structure as described in claim 5, a communication module of the first network and the communication module of the second network; wherein the first antenna and the second antenna are electrically connected to the communication module of the first network, respectively, and the third antenna is electrically connected to the communication module of the second network.

18. Electronic equipment, comprising the communication apparatus as claimed in claim 7.

19. The electronic equipment according to claim 18, wherein the electronic equipment further comprises a housing, the third antenna being provided on an inner surface or outer surface of the housing, or being embedded in the housing.

20. The electronic equipment according to claim 19, wherein the housing is made from a nonmetal material, and the third antenna is made from a metal material.
